(19) United States
(12) Patent Application Publication
(10) Pub. No.: US 2026/0205726 A1
(43) Pub. Date: Jul. 16, 2026

(54) LOUDSPEAKER ASSEMBLY

(71) Applicant: HARMAN INTERNATIONAL INDUSTRIES, INCORPORATED, Stamford, CT (US)

(72) Inventors: Zhihong YOU, Shenzhen (CN); Jong-Ron LO, Shenzhen (CN); Jianfeng ZHANG, Shenzhen (CN)

(21) Appl. No.: 19/380,762

(22) Filed: Nov. 5, 2025

(30) Foreign Application Priority Data
Nov. 8, 2024 (CN) 202411590348.0

(51) Int. Cl. H04R 1/02

(52) U.S. Cl. CPC H04R 1/026

(57) ABSTRACT

The present disclosure relates to a loudspeaker assembly. The loudspeaker assembly includes a backplate unit, the backplate unit including a backplate and a snap hook arranged in the backplate, and a hanging device, the hanging device including a hanging portion and a snap-fit member, where the backplate includes a snap-fit member guide opening, the snap-fit member being insertable into the snap-fit member guide opening, and where the hanging device is switchable between a snap-locked position and a released position. In the snap-locked position, the snap-fit member is maintained in snap-fit connection with the snap hook, thereby preventing separation of the hanging device from the backplate unit, and in the released position, the snap-fit connection of the snap-fit member with the snap-hook is released, thereby allowing separation of the hanging device from the backplate unit.

### CROSS-REFERENCE TO RELATED APPLICATIONS

This application claims priority benefit to Chinese Patent Application Number 202411590348.0 entitled “A LOUDSPEAKER ASSEMBLY,” filed Nov. 8, 2024. The subject matter of this related application is hereby incorporated herein by reference.

### BACKGROUND

### Field of the Various Embodiments

The present disclosure relates to a loudspeaker assembly.

### Description of the Related Art

With the continuous pursuit of audio equipment functionality and the demand for using audio equipment in various scenarios, higher requirements have been placed on the portability of movable audio equipment in particular. For example, when walking or exercising, users desire to carry the audio equipment or fix the audio equipment in a secure and reliable manner. However, in existing designs, either the structure of the carrying device is too complex, or the connection between the carrying device and the main unit of the audio equipment is not reliable enough and is prone to inadvertent contact to release the connection between the two.

### SUMMARY

In view of the aforementioned technical problems, the technical problem to be solved by the present disclosure lies in how to provide a portable loudspeaker with a simpler structure and more convenient operation.

To solve the aforementioned technical problem, the present disclosure provides a loudspeaker assembly. The loudspeaker assembly includes a backplate unit, the backplate unit including a backplate and a snap hook arranged in the backplate, and a hanging device, the hanging device including a hanging portion and a snap-fit member, where the backplate includes a snap-fit member guide opening, the snap-fit member being insertable into the snap-fit member guide opening, and where the hanging device is switchable between a snap-locked position and a released position, where in the snap-locked position, the snap-fit member is maintained in snap-fit connection with the snap hook, thereby preventing separation of the hanging device from the backplate unit; and in the released position, the snap-fit connection of the snap-fit member with the snap-hook is released, thereby allowing separation of the hanging device from the backplate unit.

In one or more implementations according to the present disclosure, the snap hook is supported in the backplate in an elastically pre-stressed manner such that the snap hook is maintained in the snap-fit connection with the snap-fit member under pre-stress.

In one or more implementations according to the present disclosure, the snap hook is supported in the backplate in an elastically pre-stressed manner by a biasing member.

In one or more implementations according to the present disclosure, the biasing member includes a return spring.

In one or more implementations according to the present disclosure, the backplate unit further includes a pivot shaft, where the pivot shaft extends through the snap hook, thereby enabling the snap hook to swing about the pivot shaft to enable the hanging device to switch between the snap-locked position and the released position.

In one or more implementations according to the present disclosure, the snap hook includes a first snap hook arm, a second snap hook arm opposed to the first snap hook arm, and a pivoting portion located between the first snap hook arm and the second snap hook arm, where the pivot shaft extends through the pivoting portion, and the second snap hook arm points toward the snap-fit member of the hanging device and includes a hook-shaped member for snap-fit connection with the snap-fit member.

In one or more implementations according to the present disclosure, the backplate unit further includes a pressing member, the hanging device being switched from the snap-locked position to the released position by pressing down of the pressing member.

In one or more implementations according to the present disclosure, a swing of the snap hook about the pivoting portion is achieved by the pressing down of the pressing member, where the first snap hook arm moves downward and the second snap hook arm moves upward, thereby releasing the snap-fit connection of the snap-fit member with the snap hook.

In one or more implementations according to the present disclosure, the pressing member includes a first protruding portion extending downward, the first protruding portion pointing towards the first snap hook arm.

In one or more implementations according to the present disclosure, the pressing member includes a second protruding portion extending downward, and the backplate includes a stop flange, where the second protruding portion is capable of abutting against the stop flange, thereby limiting downward movement of the pressing member.

In one or more implementations according to the present disclosure, the backplate unit further includes a mounting base, the mounting base being fixedly connected relative to the backplate, where the pivot shaft extends through the mounting base.

In one or more implementations according to the present disclosure, the mounting base includes a pivot shaft hole, where the pivot shaft extends through the pivot shaft hole.

In one or more implementations according to the present disclosure, the mounting base is threadedly connected to the backplate.

In one or more implementations according to the present disclosure, the mounting base includes a snap-fit slot, where the snap-fit slot is smaller than the snap-fit member guide opening, thereby allowing the snap-fit member of the hanging device to pass through the snap-fit slot.

In one or more implementations according to the present disclosure, the hanging portion is connected to the snap-fit member through a joint portion.

In one or more implementations according to the present disclosure, the joint portion has a greater thickness than the snap-fit member.

In one or more implementations according to the present disclosure, the snap-fit member is constructed as a snap ring.

In one or more implementations according to the present disclosure, the hanging portion is constructed as a flexible lanyard.

In one or more implementations according to the present disclosure, the hanging portion is made of a rigid material.

In one or more implementations according to the present disclosure, the hanging portion is made of metal or rigid plastic.

In one or more implementations according to the present disclosure, the hanging portion is annularly constructed and at least includes a first segment and a second segment detachably connected to the first segment.

In one or more implementations according to the present disclosure, the first segment is constructed in a C-shape.

In one or more implementations according to the present disclosure, the first segment and the second segment are connected to each other through snap-fit connection and/or threaded connection and/or hinged connection.

In one or more implementations according to the present disclosure, the backplate at least partially includes an inclined section extending downward, where the inclined section faces the snap-fit member guide opening.

### BRIEF DESCRIPTION OF THE DRAWINGS

In order to more clearly illustrate the technical solutions of the embodiments of the present disclosure, the drawings of the embodiments will be briefly introduced below. Apparently, the drawings in the following description only relate to some embodiments of the present disclosure, rather than limiting the present disclosure.

FIG. 1 schematically illustrates a perspective view of a loudspeaker assembly according to the present disclosure;

FIG. 2 schematically illustrates an exploded view of the loudspeaker assembly according to the present disclosure;

FIG. 3 schematically illustrates an exploded view of a backplate unit together with a hanging device of the loudspeaker assembly shown in FIG. 1;

FIG. 4 schematically illustrates a partial perspective view of the loudspeaker assembly shown in FIG. 1, with its hanging device in a locked position;

FIG. 5 schematically illustrates a partial cross-sectional view of the loudspeaker assembly shown in FIG. 4;

FIG. 6 schematically illustrates another partial perspective view of the loudspeaker assembly shown in FIG. 1, with its hanging device in a released position;

FIG. 7 schematically illustrates a partial cross-sectional view of the loudspeaker assembly shown in FIG. 6;

FIG. 8a schematically illustrates a front view of a hanging device according to an implementation of the present disclosure;

FIG. 8b schematically illustrates a side view of the hanging device shown in FIG. 8a;

FIG. 9a schematically illustrates a front view of a hanging device according to another implementation of the present disclosure; and

FIG. 9b schematically illustrates a side view of the hanging device shown in FIG. 9a.

### DETAILED DESCRIPTION

Embodiments of the present disclosure will be described in detail below. Examples of the embodiments are shown in the accompanying drawings, where the same or similar reference numerals always indicate the same or similar elements or elements with the same or similar functions. The embodiments described below with reference to the accompanying drawings are illustrative, which are only used to explain the present invention, and cannot be construed as limitations to the present invention.

Unless otherwise defined, the technical terms or scientific terms used here should have the ordinary meanings understood by those of ordinary skill in the field of the present disclosure. In the description of the present disclosure, it should be understood that an orientation or positional relationship indicated by the terms “center,” “longitudinal,” “lateral,” “upper,” “lower,” “front,” “back,” “left,” “right,” “vertical,” “horizontal,” “top,” “bottom,” “inner,” “outer,” etc. is an orientation or positional relationship shown based on the accompanying drawings, is only for the convenience of describing the present disclosure and simplifying the description, rather than indicating or implying that a device or element referred to must have a specific orientation or be constructed and operated in a specific orientation, and thus cannot be understood as a limitation to the present disclosure. In addition, the terms “first” and “second” are used for descriptive purposes only, and cannot be construed as indicating or implying relative importance.

The present disclosure provides a loudspeaker assembly. The loudspeaker assembly includes a backplate unit, the backplate unit including a backplate and a snap hook arranged in the backplate, and a hanging device, the hanging device including a hanging portion and a snap-fit member, where the backplate includes a snap-fit member guide opening, the snap-fit member being insertable into the snap-fit member guide opening, and where the hanging device is switchable between a snap-locked position and a released position, where in the snap-locked position, the snap-fit member is maintained in snap-fit connection with the snap hook, thereby preventing separation of the hanging device from the backplate unit, and in the released position, the snap-fit connection of the snap-fit member with the snap-hook is released, thereby allowing separation of the hanging device from the backplate unit.

In one or more implementations according to the present disclosure, the snap hook is supported in the backplate in an elastically pre-stressed manner, such that the snap hook is maintained in the snap-fit connection with the snap-fit member under pre-stress.

Consequently, accidental disengagement between the snap hook and the backplate due to inadvertent contact is reliably avoided.

In one or more implementations according to the present disclosure, the snap hook is supported in the backplate in an elastically pre-stressed manner by a biasing member.

In one or more implementations according to the present disclosure, the biasing member includes a return spring.

In one or more implementations according to the present disclosure, the backplate unit further includes a pivot shaft, where the pivot shaft extends through the snap hook, thereby enabling the snap hook to swing about the pivot shaft to enable the hanging device to switch between the snap-locked position and the released position.

In one or more implementations according to the present disclosure, the snap hook includes a first snap hook arm, a second snap hook arm opposed to the first snap hook arm, and a pivoting portion located between the first snap hook arm and the second snap hook arm, where the pivot shaft extends through the pivoting portion, and the second snap hook arm points toward the snap-fit member of the hanging device and includes a hook-shaped member for snap-fit connection with the snap-fit member.

In one or more implementations according to the present disclosure, the backplate unit further includes a pressing member, the hanging device being switched from the snap-locked position to the released position by pressing down of the pressing member.

In one or more implementations according to the present disclosure, swing of the snap hook about the pivoting portion is achieved by the pressing down of the pressing member, where the first snap hook arm moves downward and the second snap hook arm moves upward, thereby releasing the snap-fit connection of the snap-fit member with the snap hook.

In one or more implementations according to the present disclosure, the pressing member includes a first protruding portion extending downward, the first protruding portion pointing towards the first snap hook arm.

In one or more implementations according to the present disclosure, the pressing member includes a second protruding portion extending downward, and the backplate includes a stop flange, where the second protruding portion is capable of abutting against the stop flange, thereby limiting downward movement of the pressing member.

In one or more implementations according to the present disclosure, the backplate unit further includes a mounting base, the mounting base being fixedly connected relative to the backplate, where the pivot shaft extends through the mounting base.

In one or more implementations according to the present disclosure, the mounting base includes a pivot shaft hole, where the pivot shaft extends through the pivot shaft hole.

In one or more implementations according to the present disclosure, the mounting base is threadedly connected to the backplate.

In one or more implementations according to the present disclosure, the mounting base includes a snap-fit slot, where the snap-fit slot is smaller than the snap-fit member guide opening, thereby allowing the snap-fit member of the hanging device to pass through the snap-fit slot.

In one or more implementations according to the present disclosure, the hanging portion is connected to the snap-fit member through a joint portion.

In one or more implementations according to the present disclosure, the joint portion has a greater thickness than the snap-fit member.

In one or more implementations according to the present disclosure, the snap-fit member is constructed as a snap ring.

In one or more implementations according to the present disclosure, the hanging portion is constructed as a flexible lanyard.

In one or more implementations according to the present disclosure, the hanging portion is made of a rigid material.

In one or more implementations according to the present disclosure, the hanging portion is made of metal or rigid plastic.

In one or more implementations according to the present disclosure, the hanging portion is annularly constructed and at least includes a first segment and a second segment detachably connected to the first segment.

In one or more implementations according to the present disclosure, the first segment is constructed in a C-shape.

In one or more implementations according to the present disclosure, the first segment and the second segment are connected to each other through snap-fit connection and/or threaded connection and/or hinged connection.

In one or more implementations according to the present disclosure, the backplate at least partially includes an inclined section extending downward, where the inclined section faces the snap-fit member guide opening.

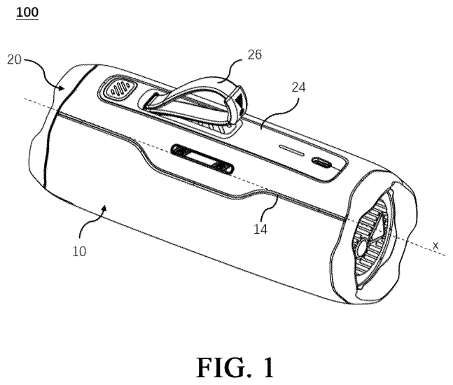

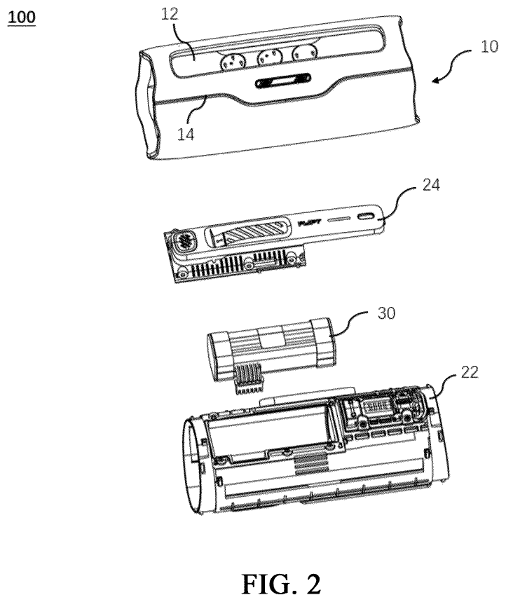

FIG. 1 schematically illustrates a perspective view of a loudspeaker assembly 100 of the present disclosure. FIG. 2 schematically illustrates an exploded view of some components of the loudspeaker assembly 100 of the present disclosure.

The loudspeaker assembly 100 is constructed as a portable loudspeaker assembly and thus has a relatively small size. The loudspeaker assembly 100 mainly includes a protective grille device 10, a main unit 20, and a battery 30, where the battery 30 is arranged inside the main unit 20 and is thus not visible from the outside.

The main unit 20 is substantially cylindrically constructed and extends elongatedly overall along an axial direction x, as shown in FIG. 1. The main unit 20 includes a base unit 22 and a backplate unit 24. In the implementation as shown in FIG. 1 to FIG. 7, the backplate unit 24 is detachably connected to the base unit 22, where the backplate unit 24 and the base unit 22 may be threadedly connected to each other by means of a plurality of bolts. However, in an implementation not shown, the base unit 22 and the backplate unit 24 may also be integrally constructed or fixedly connected to each other in an undetachable manner. The base unit 22 further includes an electroacoustic assembly and a charging assembly cooperating with the battery. The electroacoustic assembly and the charging assembly operate in a known manner and are therefore not specifically labeled nor described in detail herein.

The protective grille device 10 is made of a mesh material and has a large number of through holes arranged closely, thereby having excellent air permeability and heat dissipation performance. The protective grille device 10 itself is integrally constructed and has a split line 14 extending at least partially along the axial direction x, where the protective grille device 10 may be opened or closed along this split line 14. When the protective grille device 10 is opened, the base unit 22 of the main unit 20 is exposed; and when the protective grille device 10 is closed, it forms a cylindrical body adapted to the shape of the main unit 20 and encloses a circumferential surface of the main unit 20, while only outwardly exposing the backplate unit 24 at an opening 12. To strengthen the connection between the protective grille device 10 and the main unit 20, snaps are provided on a side of the protective grille device 10 facing the main unit 20, and correspondingly, snap slots are provided at the base unit 22 of the main unit 20. Reliable connection between the protective grille device 10 and the base unit 22 is achieved through the snaps and the snap slots, preventing accidental separation of the protective grille device 10 from the base unit 22.

As shown in FIG. 1 and FIG. 2, the protective grille device 10 has an opening 12 for the backplate unit 24, thereby enabling the backplate unit 24 to be accessible from the outside.

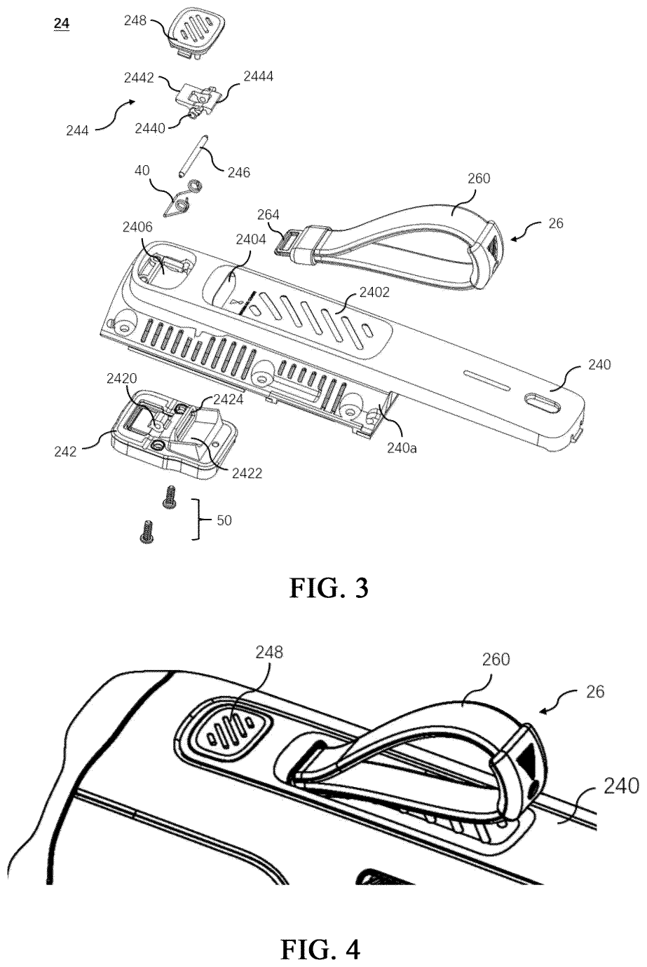

The backplate unit 24 includes a backplate 240. As particularly shown in FIG. 3, a main body section of the backplate 240 extends elongatedly, where the backplate 240 is connected to the base unit 22 by means of a backplate mounting portion 240a. In this implementation, the main body section of the backplate 240 is made of plastic, while the backplate mounting portion 240a may be made of an aluminum alloy, where the backplate 240 is integrally constructed, for example, the main body section of the backplate 240 and the backplate mounting portion 240a may be integrally constructed through an overmolding process. The overmolding process fixedly connects the main body section of the backplate 240 and the backplate mounting portion 240a lastingly and reliably, avoiding possible displacement and deviation between the two during operation. To achieve connection of the backplate 240 to the base unit 22, a plurality of through holes are provided at an edge of the backplate mounting portion 240a, and correspondingly, a corresponding number of screw holes are provided on the base unit 22 at positions corresponding thereto, and the backplate 240 is threadedly connected to the base unit 22 by means of bolts, thereby achieving a detachable connection between the base unit 22 and the backplate 240.

To improve the portability of the loudspeaker assembly 100, the backplate unit 24 is further equipped with a hanging device 26. In the assembled state of the loudspeaker assembly 100, at least a portion of region of the backplate unit 24 is exposed through the opening 12 of the protective grille device 10, and the hanging device 26 is connected from the outside to this portion of region of the backplate unit 24, thereby allowing the user to hold the hanging device 26 for carrying or grasping the loudspeaker assembly 100. As required, for example, when the protective grille device 10 needs to be removed relative to the main unit 20 for battery replacement, the connection between the hanging device 26 and the backplate unit 24 may hinder the operation. Therefore, the hanging device 26 should be detachable from the backplate unit non-destructively.

The hanging device 26 may include a hanging portion 260 and a snap-fit member 264 fixedly connected to the hanging portion 260 by means of a joint portion 262. The snap-fit member 264 is annularly constructed using a rigid material, for example, it may be constructed as a metal ring. The hanging device 26 is detachably connectable to the backplate unit 24 using the snap-fit member 264.

The hanging portion 260 may have a variety of different implementations.

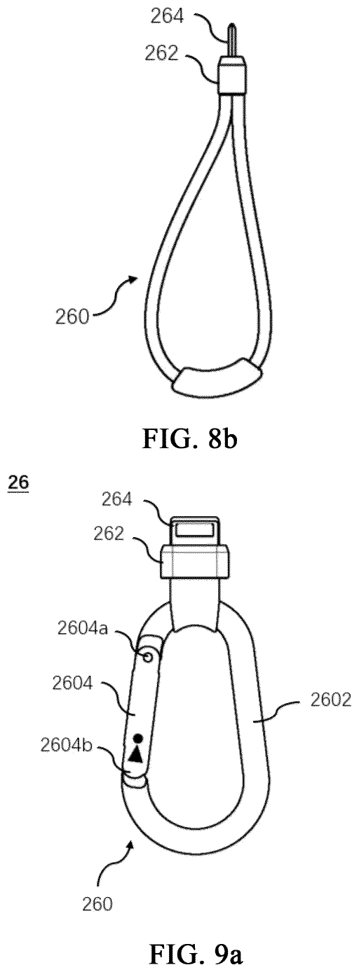

For example, in the implementation shown in FIG. 8a and FIG. 8b, the hanging portion 260 is constructed as a flexible lanyard, two ends of which are connected at the joint portion 262, thereby forming a closed hanging loop.

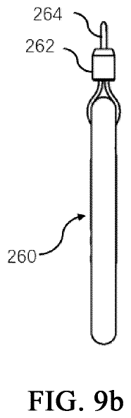

In the implementation shown in FIG. 9a and FIG. 9b, the hanging portion 260 is constructed as a hanging ring made of a rigid material, such as metal or rigid plastic. The hanging ring may include a first segment 2602 and a second segment 2604, which together form a complete hanging loop. To this end, the first segment 2602 may be constructed in a C-shape, and the second segment 2604 may be connected, by means of its two end portions, to the two mutually opposed free end portions of the first segment 2602, respectively, where a first end portion 2604a of the second segment 2604 may be pivotally connected to one end portion of the first segment 2602, and a second end portion 2604b of the second segment 2604 may be snap-fit connected to the other opposed end portion of the first segment 2602. As an alternative, in an implementation not shown, the second segment 2604 may also be threadedly connected at its second end portion 2604b to the corresponding end portion of the first segment 2602 by means of a threaded sleeve.

To enable detachable connection of the hanging device 26 relative to the backplate unit 24 in a simple manner, the backplate unit 24 further includes a mounting base 242, a snap hook 244, a pivot shaft 246, and a pressing member 248. The hanging device 26 is switchable between a snap-locked position and a released position, thereby enabling the hanging device 26 to be reliably connected to the backplate unit 24 or conveniently separated from the backplate unit 24.

The backplate 240 includes an inclined section 2402 extending downward inclinedly from the top surface, where a snap-fit member guide opening 2404, which allows the snap-fit member 264 of the hanging device 26 to be inserted therethrough, is provided at one of transition parts between the lowest point of the inclined section 2402 and the top surface, and a pressing member accommodation portion 2406 for the pressing member 248 is provided in the backplate 240.

The mounting base 242 includes a pivot shaft hole 2420 that allows the pivot shaft 246 to pass through, a base bottom 2422, and a snap-fit slot 2424 adjacent to the base bottom 2422.

The snap hook 244 includes a pivoting portion 2440 that also allows the pivot shaft 246 to pass through, and a first snap hook arm 2442 and a second snap hook arm 2444 extending from the pivoting portion 2440 to two sides, respectively, where the second snap hook arm 2444 includes a hook-shaped member at its free end portion.

The pressing member 248 is constructed in the form of a button, and the pressing member 248 includes a top surface extending substantially in a planar manner and a first protruding portion 2482 and a second protruding portion 2484 extending downward from a bottom surface thereof.

In the assembled state, the mounting base 242 is fixedly connected to the backplate 240 from below the backplate 240 by means of bolts 50, where a base bottom 2422 of the mounting base 242 may extend inclinedly. The mounting base 242 is adjacent to the inclined section 2402 of the backplate 240, thereby forming a substantially continuous channel bottom, and where an inclination of the base bottom 2422 is substantially consistent with that of the inclined section 2402 of the backplate 240. Consequently, the joint portion 262 of the hanging device 26 can be smoothly guided together with the snap-fit member 264 along the inclined section 2402 of the backplate 240 and be guided through the snap-fit member guide opening 2404 onto the base bottom 2422 of the mounting base 242, where the snap-fit slot 2424 is narrower than the snap-fit member guide opening 2404, thereby allowing the snap-fit member 264 to pass through the snap-fit slot 2424.

The pivot shaft 246 passes simultaneously through the pivot shaft hole 2420 of the mounting base 242 and the pivoting portion 2440 of the snap hook 244, where the first snap hook arm 2442 points to the direction of the pressing member 248, and the second snap hook arm 2444 points to the direction of the hanging device 26. A pre-stressing force is applied to the snap hook 244 by means of a biasing member 40, thereby causing the snap hook 244 to tend to press its second snap hook arm 2442 downward, so as to snap-fit connect with the inserted snap-fit member 264 by means of the hook-shaped member. In this implementation, the biasing member 40 is constructed as a return spring, one end of which acts on the snap hook 244, and the other end of which acts on the mounting base 242.

The pressing member 248 is movably arranged in the pressing member accommodation portion 2406. The first protruding portion 2482 of the pressing member 248 points towards the first snap hook arm 2442 of the snap hook 244, such that a pressure can be applied on the first snap hook arm 2442 through a pressing down of the pressing member 248, thereby causing the snap hook 244 to swing about the pivot shaft 246 against the pre-stressing force of the biasing member 40. To prevent excessive pressing down of the pressing member 248, an inner wall of the pressing member accommodation portion 2406 includes a stop flange 2408, where the stop flange 2408 is capable of abutting against the second protruding portion 2484 of the pressing member 248, thereby limiting downward movement of the pressing member 248.

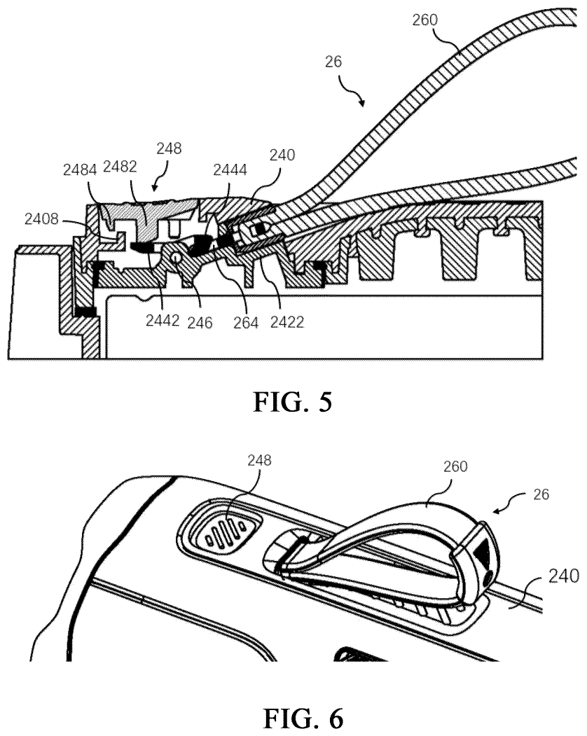

When the hanging device 26 is in the snap-locked position, as shown in FIG. 4 and FIG. 5, the snap-fit member 264 is guided together with the joint portion 262 into a guide channel formed by the backplate 240 and the base bottom 2422 of the mounting base 242, where the joint portion 262 is stopped by the snap-fit slot 2424 of the mounting base 242 due to its larger thickness, and only the snap-fit member 264 passes through the snap-fit slot 2424. Under the action of the biasing member 40, the first snap hook arm 2442 of the snap hook 244 tilts upward, and the second snap hook arm 2444 presses downward and maintains snap-fit connection with the snap-fit member 264 of the hanging device 26 by its hook-shaped member 2424.

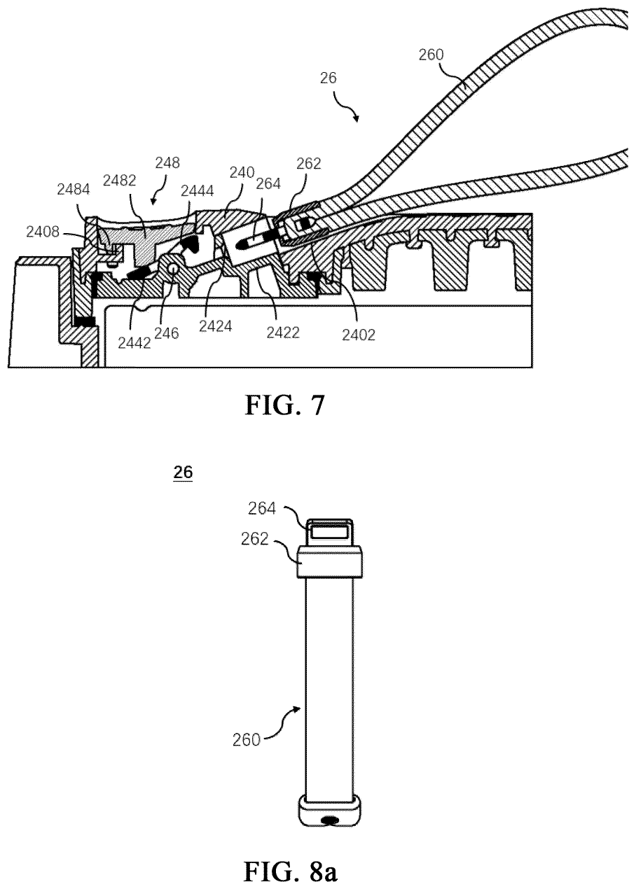

When it is desired to detach the hanging device 26 from the backplate unit 24, a pressure is applied on the top surface of the pressing member 248 to cause the pressing member 248 to move downward. During this process, the first protruding portion 2482 of the pressing member 248 applies a pressure on the first snap hook arm 2442 of the snap hook 244. Consequently, the snap hook 244 swings about the pivot shaft 246 extending through its pivoting portion 2440 against a return force of the biasing member 40, such that the first snap hook arm 2442 moves downward and the second snap hook arm 2444 tilts upward, thereby releasing the snap-fit connection between the second snap hook arm 2444 and the snap-fit member 264 of the hanging device 26 to achieve the released position of the hanging device 26. At this time, the user is allowed to pull the hanging device 26 outward to detach the hanging device 26 from the backplate unit 24, as shown in FIG. 6 and FIG. 7.

When it is desired to connect the hanging device 26 to the backplate unit 24, the joint portion 262 of the hanging device 26 together with the snap-fit member 264 is guided along the snap-fit member guide opening 2404 of the backplate 240, where the snap-fit member 264 further passes through the snap-fit slot 2424 of the mounting base 242 and acts on the second snap hook arm 2444 of the snap hook 244, thereby causing the snap hook 244 to swing about the pivot shaft 246 extending through its pivoting portion 2440. During this process, the snap hook 244 first overcomes the return force of the biasing member 40, causing the second snap hook arm 2444 to tilt upward and the first snap hook arm 2442 to press downward. After the hook-shaped member of the second snap hook arm 2444 forms snap-fit connection with the snap-fit member 264, the second snap hook arm 2444 subsequently presses downward under the return force of the biasing member 40 to achieve the snap-locked position shown in FIG. 4 and FIG. 5.

Certain features, structures, or characteristics of one or more embodiments of the present disclosure may be appropriately combined.

The present disclosure may be implemented in the following manners:

Item 1: A loudspeaker assembly, wherein the loudspeaker assembly includes a backplate unit, the backplate unit including a backplate and a snap hook arranged in the backplate, and a hanging device, the hanging device including a hanging portion and a snap-fit member, where the backplate includes a snap-fit member guide opening, the snap-fit member being insertable into the snap-fit member guide opening, and where the hanging device is switchable between a snap-locked position and a released position, where in the snap-locked position, the snap-fit member is maintained in snap-fit connection with the snap hook, thereby preventing separation of the hanging device from the backplate unit, and in the released position, the snap-fit connection of the snap-fit member with the snap-hook is released, thereby allowing separation of the hanging device from the backplate unit.

Item 2: The loudspeaker assembly according to item 1, where the snap hook is supported in the backplate in an elastically pre-stressed manner, such that the snap hook is maintained in snap-fit connection with the snap-fit member under pre-stress.

Item 3: The loudspeaker assembly according to item 1 or 2, where the snap hook is supported in the backplate in an elastically pre-stressed manner by a biasing member.

Item 4: The loudspeaker assembly according to any one of items 1-3, where the biasing member includes a return spring.

Item 5: The loudspeaker assembly according to any one of items 1-4, where the backplate unit further includes a pivot shaft, where the pivot shaft extends through the snap hook, thereby enabling the snap hook to swing about the pivot shaft to enable the hanging device to switch between the snap-locked position and the released position.

Item 6: The loudspeaker assembly according to any one of items 1-5, where the snap hook includes a first snap hook arm, a second snap hook arm opposed to the first snap hook arm, and a pivoting portion located between the first snap hook arm and the second snap hook arm, where the pivot shaft extends through the pivoting portion, and the second snap hook arm points toward the snap-fit member of the hanging device and includes a hook-shaped member for snap-fit connection with the snap-fit member.

Item 7: The loudspeaker assembly according to any one of items 1-6, where the backplate unit further includes a pressing member, the hanging device being switched from the snap-locked position to the released position by pressing down of the pressing member.

Item 8: The loudspeaker assembly according to any one of items 1-7, where swing of the snap hook about the pivoting portion is achieved by the pressing down of the pressing member, where the first snap hook arm moves downward and the second snap hook arm moves upward, thereby releasing the snap-fit connection of the snap-fit member with the snap hook.

Item 9: The loudspeaker assembly according to any one of items 1-8, where the pressing member includes a first protruding portion extending downward, the first protruding portion pointing towards the first snap hook arm.

Item 10: The loudspeaker assembly according to any one of items 1-9, where the pressing member includes a second protruding portion extending downward, and the backplate includes a stop flange, where the second protruding portion is capable of abutting against the stop flange, thereby limiting downward movement of the pressing member.

Item 11: The loudspeaker assembly according to any one of items 1-10, where the backplate unit further includes a mounting base, the mounting base being fixedly connected relative to the backplate, where the pivot shaft extends through the mounting base.

Item 12: The loudspeaker assembly according to any one of items 1-11, where the mounting base includes a pivot shaft hole, where the pivot shaft extends through the pivot shaft hole.

Item 13: The loudspeaker assembly according to any one of items 1-12, where the mounting base is threadedly connected to the backplate.

Item 14: The loudspeaker assembly according to any one of items 1-13, where the mounting base includes a snap-fit slot, where the snap-fit slot is smaller than the snap-fit member guide opening, thereby allowing the snap-fit member of the hanging device to pass through the snap-fit slot.

Item 15: The loudspeaker assembly according to any one of items 1-14, where the hanging portion is connected to the snap-fit member through a joint portion.

Item 16: The loudspeaker assembly according to any one of items 1-15, where the joint portion has a greater thickness than the snap-fit member.

Item 17: The loudspeaker assembly according to any one of items 1-16, where the snap-fit member is constructed as a snap ring.

Item 18: The loudspeaker assembly according to any one of items 1-17, where the hanging portion is constructed as a flexible lanyard.

Item 19: The loudspeaker assembly according to any one of items 1-18, where the hanging portion is made of a rigid material.

Item 20: The loudspeaker assembly according to any one of items 1-19, where the hanging portion is made of metal or rigid plastic.

Item 21: The loudspeaker assembly according to any one of items 1-20, where the hanging portion is annularly constructed and at least includes a first segment and a second segment detachably connected to the first segment.

Item 22: The loudspeaker assembly according to any one of items 1-21, where the first segment is constructed in a C-shape.

Item 23: The loudspeaker assembly according to any one of items 1-22, where the first segment and the second segment are connected to each other through snap-fit connection and/or threaded connection and/or hinged connection.

Item 24: The loudspeaker assembly according to any one of items 1-23, where the backplate at least partially includes an inclined section extending downward, where the inclined section faces the snap-fit member guide opening.

What is claimed is:

1. A loudspeaker assembly, wherein the loudspeaker assembly comprises:
a backplate unit, the backplate unit comprising a backplate and a snap hook arranged in the backplate; and
a hanging device, the hanging device comprising a hanging portion and a snap-fit member,
wherein:
the backplate comprises a snap-fit member guide opening, the snap-fit member being insertable into the snap-fit member guide opening, and
the hanging device is switchable between a snap-locked position and a released position,
in the snap-locked position, the snap-fit member is maintained in snap-fit connection with the snap hook, thereby preventing separation of the hanging device from the backplate unit; and
in the released position, the snap-fit connection of the snap-fit member with the snap hook is released, thereby allowing separation of the hanging device from the backplate unit.

2. The loudspeaker assembly according to claim 1, wherein the snap hook is supported in the backplate in an elastically pre-stressed manner, such that the snap hook is maintained in snap-fit connection with the snap-fit member under pre-stress.

3. The loudspeaker assembly according to claim 2, wherein the snap hook is supported in the backplate in an elastically pre-stressed manner by a biasing member.

4. The loudspeaker assembly according to claim 3, wherein the biasing member comprises a return spring.

5. The loudspeaker assembly according to claim 2, wherein:
the backplate unit further comprises a pivot shaft, and
the pivot shaft extends through the snap hook, thereby enabling the snap hook to swing about the pivot shaft to enable the hanging device to switch between the snap-locked position and the released position.

6. The loudspeaker assembly according to claim 5, wherein:
the snap hook comprises:
a first snap hook arm,
a second snap hook arm opposed to the first snap hook arm, and
a pivoting portion located between the first snap hook arm and the second snap hook arm,
the pivot shaft extends through the pivoting portion, and the second snap hook arm points toward the snap-fit member of the hanging device and comprises a hook-shaped member for snap-fit connection with the snap-fit member.

7. The loudspeaker assembly according to claim 6, wherein the backplate unit further comprises a pressing member, the hanging device being switched from the snap-locked position to the released position by pressing down of the pressing member.

8. The loudspeaker assembly according to claim 7, wherein:
swing of the snap hook about the pivoting portion is achieved by the pressing down of the pressing member, and
the first snap hook arm moves downward and the second snap hook arm moves upward, thereby releasing the snap-fit connection of the snap-fit member with the snap hook.

9. The loudspeaker assembly according to claim 8, wherein the pressing member comprises a first protruding portion extending downward, the first protruding portion pointing towards the first snap hook arm.

10. The loudspeaker assembly according to claim 8, wherein:
the pressing member comprises a second protruding portion extending downward,
the backplate comprises a stop flange, and
the second protruding portion is capable of abutting against the stop flange, thereby limiting downward movement of the pressing member.

11. The loudspeaker assembly according to claim 5, wherein:
the backplate unit further comprises a mounting base, the mounting base being fixedly connected relative to the backplate, and
the pivot shaft extends through the mounting base.

12. The loudspeaker assembly according to claim 11, wherein:
the mounting base comprises a pivot shaft hole, and
the pivot shaft extends through the pivot shaft hole.

13. The loudspeaker assembly according to claim 11, wherein the mounting base is threadedly connected to the backplate.

14. The loudspeaker assembly according to claim 11, wherein:
the mounting base comprises a snap-fit slot, and
the snap-fit slot is smaller than the snap-fit member guide opening, thereby allowing the snap-fit member of the hanging device to pass through the snap-fit slot.

15. The loudspeaker assembly according to claim 1, wherein the hanging portion is connected to the snap-fit member through a joint portion.

16. The loudspeaker assembly according to claim 15, wherein the joint portion has a greater thickness than the snap-fit member.

17. The loudspeaker assembly according to claim 1, wherein the snap-fit member is constructed as a snap ring.

18. The loudspeaker assembly according to claim 1, wherein the hanging portion is constructed as a flexible lanyard.

19. The loudspeaker assembly according to claim 1, wherein the hanging portion is made of a rigid material.

20. The loudspeaker assembly according to claim 19, wherein the hanging portion is made of metal or rigid plastic.
